(19) United States
(12) Patent Application Publication
(10) Pub. No.: US 2023/0360430 A1
(43) Pub. Date: Nov. 9, 2023

(54) FACE DETECTOR USING POSITIONAL PRIOR FILTERING

(71) Applicant: ObjectVideo Labs, LLC, Tysons, VA (US)

(72) Inventors: Gang Qian, McLean, VA (US); Eric Rodney Carlson, Oakton, VA (US); Allison Beach, Leesburg, VA (US)

(21) Appl. No.: 18/142,627

(22) Filed: May 3, 2023

Related U.S. Application Data
(60) Provisional application No. 63/338,599, filed on May 5, 2022.

(51) Int. Cl. G06V 40/16; G06V 10/774; G06V 10/776; G06V 10/26; G07C 9/00

(52) U.S. Cl. CPC G06V 40/165; G06V 10/774; G06V 10/776; G06V 40/171; G06V 10/26; G07C 9/00563

(57) ABSTRACT

Methods, systems, and apparatus, including computer programs encoded on computer storage media, for object detection using positional prior filtering. One of the methods includes: obtaining, from a plurality of first images, person bounding boxes and face bounding boxes that each correspond to one of the person bounding boxes, each person bounding box identifying at least one portion of a respective image of the plurality of first images that likely represents a person; training a face location predictor to predict a location of a face in an image using the person bounding boxes and the face bounding boxes; training, using the face location predictor, an error model that determines a likelihood that an image depicts a face using output from the face location predictor; and storing, in memory, the trained error model, and the face location predictor for use by a device detecting faces depicted in an image.

### CLAIM OF PRIORITY

This application claims priority under 35 USC § 119(e) to U.S. Patent Application Ser. No. 63/338,599, filed on May 5, 2022, the entire contents of which are hereby incorporated by reference.

### TECHNICAL FIELD

This disclosure application relates generally to monitoring systems, and more particularly, to detecting events.

### SUMMARY

Techniques are described for detecting faces. Detecting faces may be important for a monitoring system. For example, face detection may be used to identify whether a person at a front door is a home owner for which the front door should automatically unlock or another person for which the front door should remain locked. However, home surveillance videos can be noisy due to low contrast, unideal lighting conditions, compression artifacts, or a combination of these. Reliable detection of person faces from such noisy surveillance image frames may not be a trivial task, and face detection results can sometimes be prone to false face detections.

A system, e.g., a training system or runtime system or both, can use positional filtering to reduce false face detections. Filtering by position may leverage the fact that in video analytics pipelines, face detection may follow person detection. For example, in a doorbell video analytics pipeline, face detection may not be invoked until a person is detected. Once a person is detected by a person detector, face detection may be done within a region of interest given the detected person bounding box. Positional filtering may train a regressor using features extracted from the person bounding box to estimate a prior, e.g., a condition, of the location and size of the face bounding box inside the given person bounding box.

Once the regressor is trained, the resulting estimated location and size prior of the face can be used as the prior to properly weight the face detection bounding boxes from the face detector. The system can use the weights to filter out false face detections that are far away from the prior.

In general, one innovative aspect of the subject matter described in this specification can be embodied in methods that include the actions of: obtaining, from at least one image in a multiple first images, one or more person bounding boxes and one or more face bounding boxes that each correspond to one of the one or more the person bounding boxes; training a face location predictor to predict a location of a face in an image using the one or more person bounding boxes and the one or more face bounding boxes; training, using the face location predictor, an error model that determines a likelihood that an image depicts a face using output from the face location predictor; and storing, in memory, the trained error model, and the face location predictor for use by a device detecting one or more faces depicted in an image. Each person bounding box can identify at least one portion of a respective image of the multiple first images that likely represents a person.

In another innovative aspect of the subject matter described in this specification can be embodied in methods that include the actions of: detecting a face candidate depicted in an image using data for the image and a face location predictor that was trained to predict a location of a face in an image using one or more person bounding boxes and one or more face bounding boxes that each correspond to one of the one or more the person bounding boxes, determining a likelihood that the image actually depicts a face using an error model that determines likelihoods that images depict at least one face using output from the face location predictor; determining, using a face detector that detects faces in images using data from the face location predictor and the error model, whether the face candidate satisfies a threshold likelihood of representing an actual face depicted in the image; and in response to determining whether the face candidate satisfies the threshold likelihood of representing an actual face depicted in the image, selectively performing one or more automated actions using data for the face or determining to skip performing the one or more automated actions.

Implementations of the described techniques may include hardware, a method or process implemented at least partially in hardware, or a computer-readable storage medium encoded with executable instructions that, when executed by a processor, perform operations.

The details of one or more implementations are set forth in the accompanying drawings and the description below. Other features will be apparent from the description and drawings, and from the claims.

The foregoing and other embodiments can each optionally include one or more of the following features, alone or in combination.

In some implementations, the operations further include: receiving one or more input images; determining whether each of the one or more input images likely depicts at least one person; for each of the one or more input images that likely depict at least one person, generating a corresponding person bounding box; and selecting, as the multiple first images, the one or more input images that each likely depict at least one person.

In some implementations, detecting a face depicted in an image using the face location predictor, the error model, and a face detector that detects faces in images using data from the face location predictor and the error model; and in response to detecting the face depicted in the image, performing one or more automated actions using data for the face.

In some implementations, performing the one or more automated actions using the data for the face includes: determining, for the face, one or more face prior values that include at least one of a face bounding box center location, or a face bounding box size; determining a difference between the determined one or more face prior values and one or more ground-truth values; and performing the one or more automated actions in response to determining that the difference between the determined one or more face prior values and the one or more ground-truth values satisfies a difference threshold.

In some implementations, detecting the face using the face location predictor, the error model, and the face detector includes: determining, for the face, a likelihood that the face is a false detection; and determining that the likelihood satisfies a threshold likelihood; and performing the one or more automated actions is responsive to determining that the likelihood satisfies the threshold likelihood.

In some implementations, performing the one or more automated actions using the data for the face includes sending, to a device, instructions to cause the device to lock or unlock a door.

In some implementations, obtaining the one or more person bounding boxes and the one or more face bounding boxes of includes: for each person bounding box: extracting, using the respective person bounding box and image from the multiple first images, features i) from the image, and ii) that include a combination of one or more of a person box size, a person center position, or a person footprint position; using the extracted features for each person bounding box, determining a predicted location and a predicted size of a face associated with the person bounding box; and using the predicted location and the predicted size of the face associated with the person bounding box, generating a face bounding box corresponding to the respective person bounding box.

In some implementations, training the face location predictor using the one or more person bounding boxes and the one or more face bounding boxes includes: determining that a portion of at least a first image i) of the multiple first images and ii) that corresponds to a person bounding box satisfies a likelihood threshold of depicting a face; and training the face location predictor using at least the first image.

In some implementations, training the face location predictor using the one or more person bounding boxes and the one or more face bounding boxes includes: determining that a portion of at least a second image i) of the multiple first images and ii) that corresponds to a person bounding box does not satisfy a likelihood threshold of including a face; and determining to skip training the face location predictor using the second image.

In some implementations, obtaining the one or more person bounding boxes and the one or more face bounding boxes includes: obtaining the one or more person bounding boxes; in response to obtaining the one or more person bounding boxes, cropping a subset of images from the multiple first images to only include portions of the respective first image that are within a respective person bounding box from the one or more person bounding boxes; and obtaining, using the cropped subset of images from the multiple first images, the one or more face bounding boxes.

In some implementations, training the face location predictor uses a combination of one or more person bounding box features. The one or more person bounding box features can include at least one of a person bounding box size, a person bounding box aspect ratio, a predicted person center position, or a predicted person footprint position.

In some implementations, the method includes performing the one or more automated actions using the data for the face.

In some implementations, performing the one or more automated actions using the data for the face includes: determining, for the face, one or more face prior values that include at least one of a face bounding box center location, or a face bounding box size; determining a difference between the determined one or more face prior values and one or more ground-truth values; and performing the one or more automated actions in response to determining that the difference between the determined one or more face prior values and the one or more ground-truth values satisfies a difference threshold.

In some implementations, performing the one or more automated actions using the data for the face includes sending, to a device, instructions to cause the device to lock or unlock a door.

In some implementations, determining whether the face candidate satisfies a threshold likelihood of representing an actual face depicted in the image includes: determining, for the face, whether the likelihood satisfies the threshold likelihood of representing an actual face and being a true face detection; and in response to determining that the likelihood satisfies the threshold likelihood of representing an actual face and being a true face detection, performing facial recognition for the face; and performing the one or more automated actions uses data representing a result of the facial recognition for the face.

The subject matter described in this specification can be implemented in various embodiments and may result in one or more of the following advantages. For example, the accuracy of a face recognition model can be improved by using positional prior filtering. Positional prior filtering can include detecting a person and then detecting a face using data from the person detection. In some implementations, detecting and recognizing a face can use fewer computer resources when using positional prior filtering compared to other systems. For example, a system can analyze less of an image, e.g., a cropped image likely including a face, instead of an entire image, which uses fewer computer resources and memory. Due to systems analyzing less of an image, in some implementations, facial detection and recognition can be faster in systems that utilize positional prior filtering.

In some implementations, such as when the facial recognition model is integrated with a home monitoring system, utilizing positional prior filtering can lead to fewer resources being used in operating appliances, improving security, or both. For example, when the system recognizes a resident, the system can initiate user-defined preferences, such as turning on a ceiling fan, rather than constantly running a ceiling fan. In some examples, when the system detects an unrecognized face, the system can lock doors, thereby improving security.

In some implementations, detecting a person but not a face can suggest the detected person is likely traversing away from the property, which can trigger certain actions in the home monitoring system.

In some implementations, positional prior filtering can be used to improve accuracy of detection of objects other than faces, such as hands, torsos, legs, feet, license plates, windows, and wheels.

### DESCRIPTION OF DRAWINGS

FIG. 1 illustrates an example block diagram of a system for using positional prior filtering.

FIG. 2 illustrates an example block diagram of a system for training a face predictor.

FIG. 3 illustrates an example block diagram of a system for generating error models for face prediction.

FIG. 4 is a flow diagram of an example process for using positional prior filtering.

FIG. 5 is a diagram illustrating an example of a property monitoring system.

Like reference numbers and designations in the various drawings indicate like elements

### DETAILED DESCRIPTION

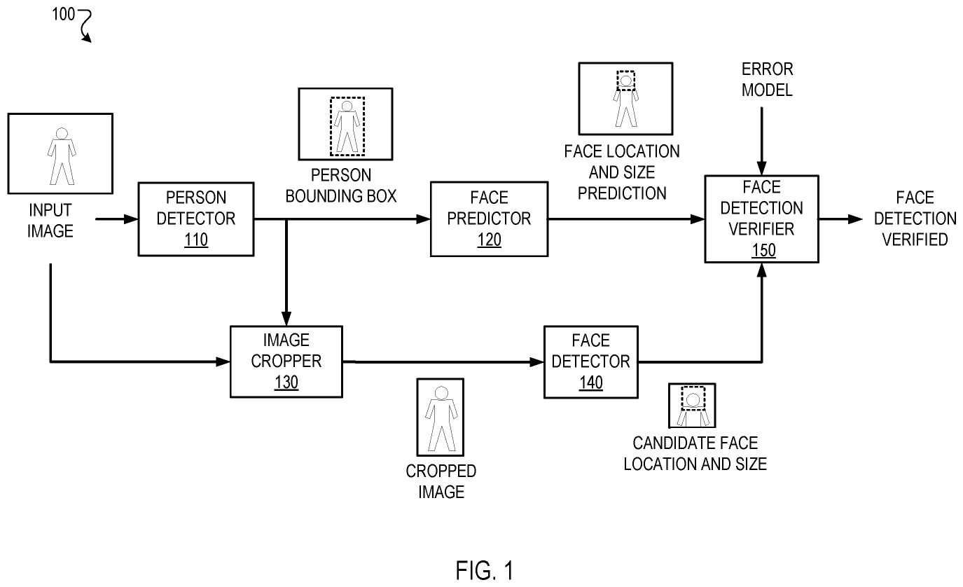

FIG. 1 illustrates a system 100 for using positional prior filtering. The system 100 includes a person detector 110 that generates a bounding box around a detected human, a face predictor 120 that predicts where a face will be using size and location of the bounding box around the detected human, an image cropper 130 that crops an image to focus on portions that are likely to show a face, a face detector 140 that detects human faces, and a face detection verifier 150 that verifies, with the prediction from the face predictor 120 and an error model, whether a face that was detected by the face detector 140 is a face. The person detector 110, face predictor 120, image cropper 130, face detector 140, and face detection verifier 150 may be implemented on one or more computing devices, using one or more data processing apparatuses, or both.

The person detector 110 may receive an input image, detect a human, and indicate a person bounding box around the detected human. For example, the person detector 110 may be a neural network that is trained to detect humans using training images of images and person bounding boxes. A person bounding box may be a small detected rectangle, e.g., the smallest detected rectangle, that includes all portions of the image that show the detected human. The person detector 110 may indicate the bounding box by outputting features of the bounding box. For example, the person detector 110 may output coordinates of the center of the person bounding box as (960, 540) and a height of 950 pixels and width of 200 pixels for the person bounding box.

The face predictor 120 may receive an indication of a person bounding box and, optionally, an image, e.g., the input image or a cropped image. The face predictor 120 can output a prediction of a location and size of a face in the input image. For example, the face predictor 120 may output an indication that the face is centered at the coordinates (1200, 540) and has a height of 150 pixels and a width of 100 pixels.

In some implementations, the face predictor 120 may extract features from the person bounding box and generate the face location and size prediction using the extracted features. For example, the face predictor 120 may extract a person bounding box size=(Wₕ, Hₕ),

$$a person bounding box aspect ratio = \frac{{W}_{h}}{{H}_{h}} ,$$

a person center position=(Xₕ, Yₕ),

$$person footprint position = ( {X}_{h} , {Y}_{h} + \frac{1}{2} {H}_{h} ) ,$$

or a combination of two or more of these. In the above equations, Hₕ and Wₕ are the height and width of the person bounding box, and Xₕ and Yₕ are the column and row locations of the person bounding box. One or more of these values, e.g., all of these values, can be normalized by the image height.

The image cropper 130 may receive the input image, receive the indication of the person bounding box and output a cropped image. For example, the image cropper 130 may output a cropped image that only includes the portions of the image that are within the person bounding box.

The face detector 140 may receive the cropped image, detect a candidate face, and output a candidate face location and size. For example, the face detector 140 may receive a cropped image that only includes the portion of the input image in the person bounding box, detect a candidate face in an upper middle of the cropped image, and determine a center, height, and width of a face bounding box. A face bounding box may be a small detected rectangle, e.g., the smallest detected rectangle, that includes all portions of a face shown in an image. The face detector 140 can output data for the face bounding box, e.g., values similar to the person bounding box, or other appropriate data.

The face detection verifier 150 may receive the face location and size prediction from the face predictor 120, and the candidate face location and size detected by the face detector 140, and verify the detection using an error model. For example, the face detection verifier 150 may determine that a difference between the prediction and the candidate indicates a low likelihood of a match using the error model and, in response, output an indication that the candidate face detection is likely false. In another example, the face detection verifier 150 may determine that a difference between the prediction and the candidate indicates a high likelihood of a match using the error model and, in response, output an indication that the candidate face detection is likely true.

The system 100 can determine whether to perform an action using the output of the face detection verifier 150. For instance, when the indication is that the candidate face detection is likely false, the system 100 can determine to skip further analysis of the candidate face, e.g., determine that there is not likely a face for further analysis. When the indication is that the candidate face detection is likely true, the system 100 can determine to send data of the face to the face recognition algorithm or other attribute extraction algorithms.

In some implementations, the error model may include two or more submodels. For example, the error model may include a first submodel for size error and second submodel for location error. The face detection verifier 150 may verify the candidate face detected using a result that indicates whether the sized satisfy a similarity value threshold, the locations satisfy a location similarity threshold, or both.

In a more detailed example, the face detector 140 may detect multiple candidate faces in an image. For each face detection candidate, the face detection verifier 150 can determine the difference between the face detection candidate and the face prediction. The face detection verifier 150 can represent the difference in an error vector, e.g., in terms of face size and face location. The face detection verifier 150 can provide the resulting error vectors to the error submodels to compute the probabilities of errors as respective scores of the face detection candidates. Face candidates receiving lower scores may be determined to likely be false detections and removed from a list of face detection candidates for analysis by the face detector 140. Face candidates receiving higher scores may be determined to likely not be false detections and maintained in the list of face detection candidates for analysis by the face detector 140.

The positional filtering concept may be applied to many two-step video analytics pipelines, where a subsequent detection algorithm is run to learn more detailed information about the object based on the first broader level detection. For instance, to detect if a person is wearing a hat, the system 100 can train and use a hat prior estimator to predict the prior location and size of the hat given a face bounding box. The same concept could be applied to detecting glasses and other appropriate objects that a person may carry.

Some additional examples could be to apply the idea to detecting a backpack worn by someone detected inside a person bounding box, or to detecting a hand-carried object with different priors depending on the method of carry, such as an object carried at a person's side like a bag or briefcase, or an object carried within a torso bounding box, such as a child, or parcel. The concept can also be applied to non-people objects, for example a system could use the same process to learn where to look for a license plate on a car.

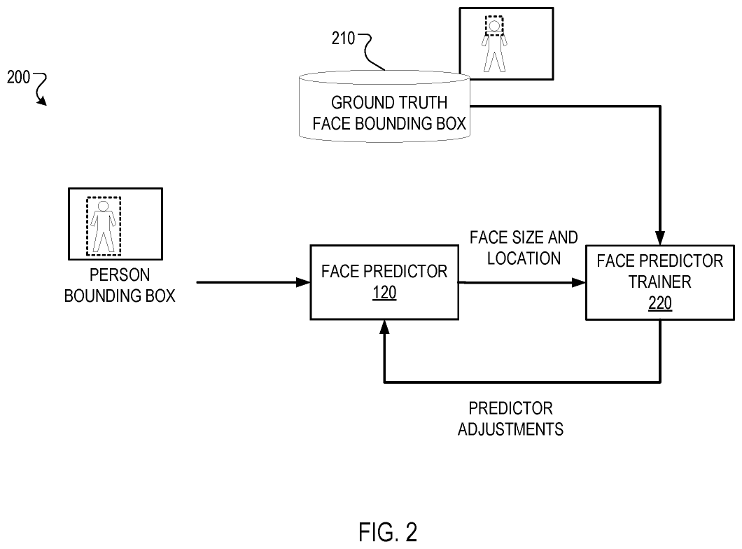

FIG. 2 illustrates an example block diagram of a system 200 for training a face predictor. The system 200 includes the face predictor 120 that predicts a location, size, or both, of a face using an indication of a person bounding box, ground truth face bounding box data store 210 that stores training data, and a face predictor trainer 220 that trains the face predictor 120 using the training data. The face predictor 120 may be trained to predict the normalized face center location and face bounding box size, where all values are normalized by the height of the person bounding box from a set of training data.

In some implementations, the training data includes the input person bounding box location and size in the original image frame and the actual location and size of the face bounding box inside the corresponding person bounding box. The face predictor may be a regressor, e.g., the linear regression model with L2 regularization (e.g., a ridge regressor).

The face predictor trainer 220 can receive a prediction output from the face predictor 120 and provide one or more predictor adjustments to the face predictor 120 given the received prediction output. For instance, the face predictor trainer 220 can determine the ground truth training data that corresponds to the prediction output. The face predictor trainer 220 can determine an accuracy of the prediction output using the ground truth training data. The face predictor trainer 220 can determine the predictor adjustments using the accuracy of the prediction output, the comparison of the ground truth training data with the prediction output, or a combination of both.

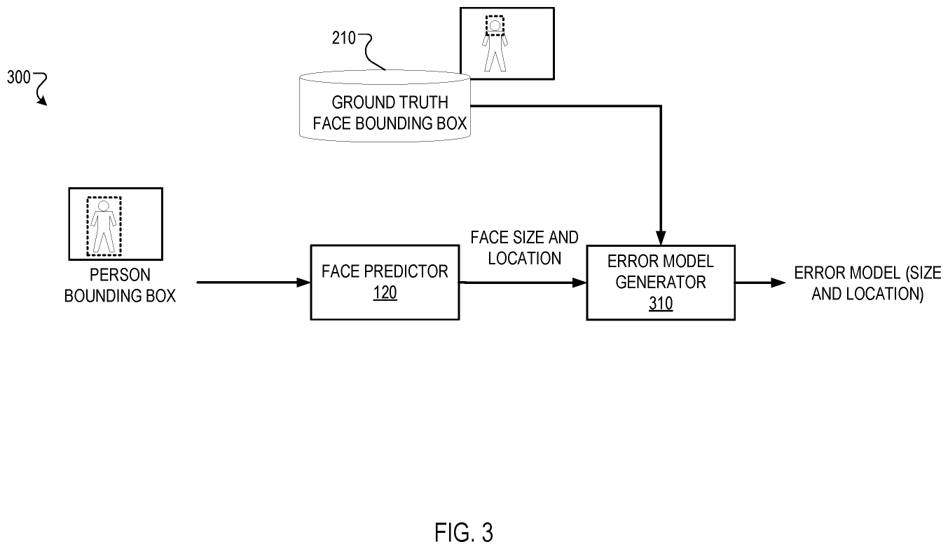

FIG. 3 illustrates an example block diagram of a system 300 for generating error models for face prediction. The system 300 is one example of a runtime system that can determine whether an image depicts a face and whether to perform an action using a result of the face depiction determination. The system 300 includes the face predictor 120 that predicts face locations, sizes, or both, the ground truth face bounding box data store 210 that stores training data, and the error model generator 310 that generates the error model using the predicted face size and location and the training data.

Once the face prior estimator is trained, the error model may be generated to capture the underlying uncertainty in the face prior regression results. The error model may then serve as a fitness measure given a face prediction from the face detector.

As shown in FIG. 3, once the face predictor 120 is trained, e.g., using the same set of training data used in the regressor training described with reference to FIG. 2, the error model generator 310 may compute the regression errors in the face prior regression output, e.g., face box center location and face box size, in terms of the difference between the estimated face prior values and the ground-truth values. The error model generator 310 may then use two 2D-Gaussian distributions to model the prior errors, one for the face size prior error, and the other for the face center location prior error.

Once the error model is generated, the system 300 or another system, can use the error model to determine a likelihood that an image depicts a face. The system can then use the likelihood to determine whether to perform an action. For instance, the system can determine whether the likelihood satisfies a threshold likelihood. If not, the system can determine to skip further analysis of the image.

If the likelihood satisfies the threshold likelihood, the system can determine an action to perform. For instance, the system can compare data for the face with data that represents one or more known faces. When the system determines that the face represents a known face, using a result of the comparison, the system can perform another action, e.g., automatically unlock a door when the face represents a property owner.

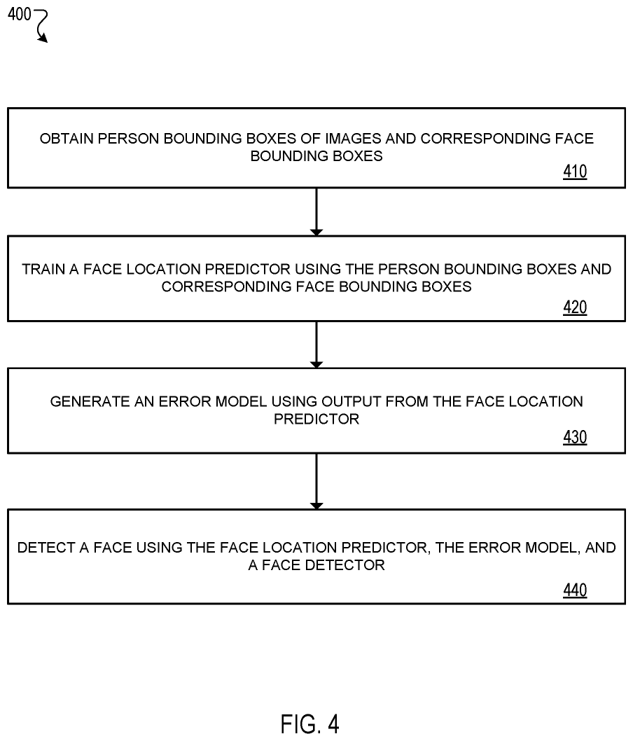

FIG. 4 is a flow diagram of an example process 400 for using positional prior filtering. The process 400 may be implemented using the systems 100, 200, and 300 described above. Thus, descriptions of process 400 may reference one or more of the above-mentioned components, modules, or computational devices of systems 100, 200, and 300. In some implementations, described actions of process 400 are enabled by computing logic or software instructions executable by a processor and memory of an example electronic device.

Briefly, and as will be described in more detail below, the process 400 includes obtaining person bounding boxes of images and corresponding face bounding boxes (410), training a face location predictor using the person bounding boxes and corresponding face bounding boxes (420), generating an error model using output from the face location predictor (430), and detecting a face using the face location predictor, the error model, and the face detector (440). The process can optionally include more or fewer steps. For instance, the process can include only steps 410, 420, and 430 without step 440. In some examples, the process can include only step 440 without the other steps.

The process 400 includes obtaining person bounding boxes of images and corresponding face bounding boxes (410). For example, the face predictor trainer 220 may obtain training data that includes images, person bounding boxes for the images, and face bounding boxes for the images.

The process 400 includes training a face location predictor using the person bounding boxes and corresponding face bounding boxes (420). For example, the face predictor trainer 220 may train the face predictor 120 to predict the face size, location, or both, using a loss function and the training data.

The process 400 includes generating an error model using output from the face location predictor (430). For example, the error model generator 310 may generate the error model using the face bounding boxes indicated by the training data and the face location, size, or both, predicted by the face predictor 120 from person bounding boxes indicated by at least some of the output data from the face location predictor. In some examples, the error model generator 310 can train the error model.

In some implementations, the process 400 can store, in memory, the trained error model, and the face location predictor for use by a device detecting one or more faces depicted in an image. For instance, the system 100 can store the face predictor 120 and the error model in the memory.

The process 400 includes detecting a face using the face location predictor, the error model, and the face detector (440). For example, the system can provide the face location predictor, the error model, and the face detector to a device, e.g., a runtime system, after training and generation. The runtime system can receive the location predictor, the error model, and the face detector. The runtime system can use the face detection verifier 150 to verify whether a candidate face indicated by the face detector 140 likely is a face using the face location and size prediction from the face predictor 120 and the error model generated by the error model generator 310. When the runtime system determines that the candidate face likely is a face, the runtime system can perform an action, e.g., an automated action. When the runtime system determines that the candidate face likely is not a face, the runtime system can determine to skip performing any additional actions for that candidate face. This can reduce an amount of resource used by the runtime system, an accuracy of when the runtime system performs actions given candidate faces, or both.

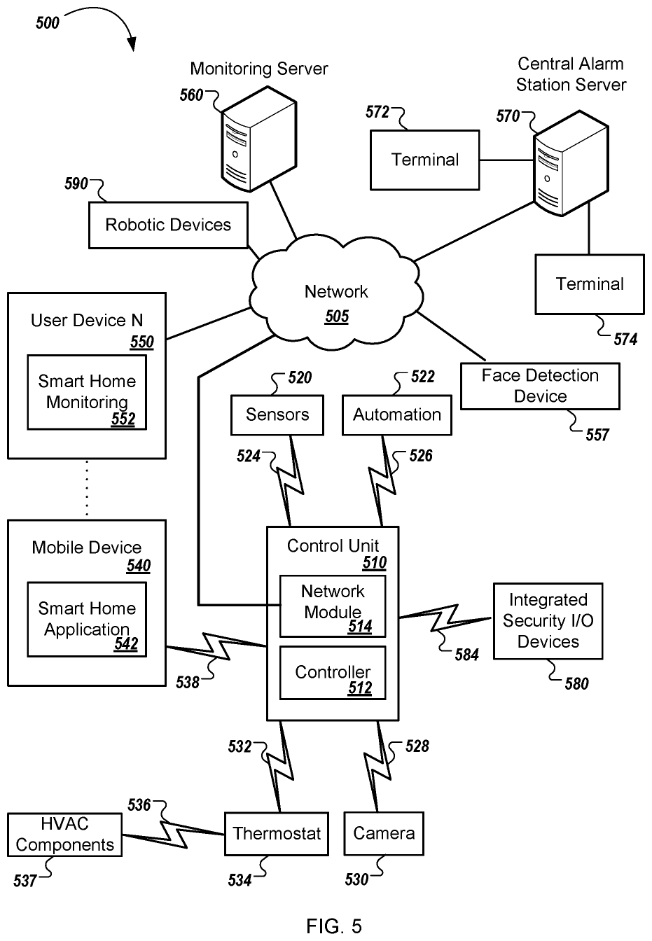

FIG. 5 is a diagram illustrating an example of a property monitoring system 500. The property monitoring system 500 includes a network 505, a control unit 510, one or more user devices 540 and 550, a monitoring server 560, and a central alarm station server 570. In some examples, the network 505 facilitates communications between the control unit 510, the one or more user devices 540 and 550, the monitoring server 560, and the central alarm station server 570.

The network 505 is configured to enable exchange of electronic communications between devices connected to the network 505. For example, the network 505 may be configured to enable exchange of electronic communications between the control unit 510, the one or more user devices 540 and 550, the monitoring server 560, and the central alarm station server 570. The network 505 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 505 may include multiple networks or subnetworks, each of which may include, for example, a wired or wireless data pathway. The network 505 may include a circuit-switched network, a packet-switched data network, or any other network able to carry electronic communications (e.g., data or voice communications). For example, the network 505 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 505 may include one or more networks that include wireless data channels and wireless voice channels. The network 505 may be a wireless network, a broadband network, or a combination of networks including a wireless network and a broadband network.

The control unit 510 includes a controller 512 and a network module 514. The controller 512 is configured to control a control unit monitoring system (e.g., a control unit system) that includes the control unit 510. In some examples, the controller 512 may include a processor or other control circuitry configured to execute instructions of a program that controls operation of a control unit system. In these examples, the controller 512 may be configured to receive input from sensors, flow meters, or other devices included in the control unit system and control operations of devices included in the household (e.g., speakers, lights, doors, etc.). For example, the controller 512 may be configured to control operation of the network module 514 included in the control unit 510.

The network module 514 is a communication device configured to exchange communications over the network 505. The network module 514 may be a wireless communication module configured to exchange wireless communications over the network 505. For example, the network module 514 may be a wireless communication device configured to exchange communications over a wireless data channel and a wireless voice channel. In this example, the network module 514 may transmit alarm data over a wireless data channel and establish a two-way voice communication session over a wireless voice channel. The wireless communication device may include one or more of a LTE module, a GSM module, a radio modem, a cellular transmission module, or any type of module configured to exchange communications in one of the following formats: LTE, GSM or GPRS, CDMA, EDGE or EGPRS, EV-DO or EVDO, UMTS, or IP.

The network module 514 also may be a wired communication module configured to exchange communications over the network 505 using a wired connection. For instance, the network module 514 may be a modem, a network interface card, or another type of network interface device. The network module 514 may be an Ethernet network card configured to enable the control unit 510 to communicate over a local area network and/or the Internet. The network module 514 also may be a voice band modem configured to enable the alarm panel to communicate over the telephone lines of Plain Old Telephone Systems (POTS).

The control unit system that includes the control unit 510 includes one or more sensors. For example, the monitoring system 500 may include multiple sensors 520. The sensors 520 may include a lock sensor, a contact sensor, a motion sensor, or any other type of sensor included in a control unit system. The sensors 520 also may include an environmental sensor, such as a temperature sensor, a water sensor, a rain sensor, a wind sensor, a light sensor, a smoke detector, a carbon monoxide detector, an air quality sensor, etc. The sensors 520 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart-rate, respiration rate, sugar or glucose level, bodily temperature, or motion data. The sensors 520 can also include a radio-frequency identification (RFID) sensor that identifies a particular article that includes a pre-assigned RFID tag.

The control unit 510 communicates with the home automation controls 522 and a camera 530 to perform monitoring. The home automation controls 522 are connected to one or more devices that enable automation of actions in the home. For instance, the home automation controls 522 may be connected to one or more lighting systems and may be configured to control operation of the one or more lighting systems. Also, the home automation controls 522 may be connected to one or more electronic locks at the home and may be configured to control operation of the one or more electronic locks (e.g., control Z-Wave locks using wireless communications in the Z-Wave protocol). Further, the home automation controls 522 may be connected to one or more appliances at the home and may be configured to control operation of the one or more appliances. The home automation controls 522 may include multiple modules that are each specific to the type of device being controlled in an automated manner. The home automation controls 522 may control the one or more devices based on commands received from the control unit 510. For instance, the home automation controls 522 may cause a lighting system to illuminate an area to provide a better image of the area when captured by a camera 530.

The camera 530 may be a video/photographic camera or other type of optical sensing device configured to capture images. For instance, the camera 530 may be configured to capture images of an area within a building or home monitored by the control unit 510. The camera 530 may be configured to capture single, static images of the area or video images of the area in which multiple images of the area are captured at a relatively high frequency (e.g., thirty images per second) or both. The camera 530 may be controlled based on commands received from the control unit 510.

The camera 530 may be triggered by several different types of techniques. For instance, a Passive Infra-Red (PIR) motion sensor may be built into the camera 530 and used to trigger the camera 530 to capture one or more images when motion is detected. The camera 530 also may include a microwave motion sensor built into the camera and used to trigger the camera 530 to capture one or more images when motion is detected. The camera 530 may have a “normally open” or “normally closed” digital input that can trigger capture of one or more images when external sensors (e.g., the sensors 520, PTR, door/window, etc.) detect motion or other events. In some implementations, the camera 530 receives a command to capture an image when external devices detect motion or another potential alarm event. The camera 530 may receive the command from the controller 512 or directly from one of the sensors 520.

In some examples, the camera 530 triggers integrated or external illuminators (e.g., Infra-Red, Z-wave controlled “white” lights, lights controlled by the home automation controls 522, etc.) to improve image quality when the scene is dark. An integrated or separate light sensor may be used to determine if illumination is desired and may result in increased image quality.

The camera 530 may be programmed with any combination of time/day schedules, system “arming state”, or other variables to determine whether images should be captured or not when triggers occur. The camera 530 may enter a low-power mode when not capturing images. In this case, the camera 530 may wake periodically to check for inbound messages from the controller 512. The camera 530 may be powered by internal, replaceable batteries, e.g., if located remotely from the control unit 510. The camera 530 may employ a small solar cell to recharge the battery when light is available. The camera 530 may be powered by the controller's 512 power supply if the camera 530 is co-located with the controller 512.

In some implementations, the camera 530 communicates directly with the monitoring server 560 over the Internet. In these implementations, image data captured by the camera 530 does not pass through the control unit 510 and the camera 530 receives commands related to operation from the monitoring server 560.

The system 500 also includes thermostat 534 to perform dynamic environmental control at the home. The thermostat 534 is configured to monitor temperature and/or energy consumption of an HVAC system associated with the thermostat 534, and is further configured to provide control of environmental (e.g., temperature) settings. In some implementations, the thermostat 534 can additionally or alternatively receive data relating to activity at a home and/or environmental data at a home, e.g., at various locations indoors and outdoors at the home. The thermostat 534 can directly measure energy consumption of the HVAC system associated with the thermostat, or can estimate energy consumption of the HVAC system associated with the thermostat 534, for example, based on detected usage of one or more components of the HVAC system associated with the thermostat 534. The thermostat 534 can communicate temperature and/or energy monitoring information to or from the control unit 510 and can control the environmental (e.g., temperature) settings based on commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In addition, the control unit 510 can be a gateway device that communicates with the dynamically programmable thermostat 534. In some implementations, the thermostat 534 is controlled via one or more home automation controls 522.

A module 537 is connected to one or more components of an HVAC system associated with a home, and is configured to control operation of the one or more components of the HVAC system. In some implementations, the module 537 is also configured to monitor energy consumption of the HVAC system components, for example, by directly measuring the energy consumption of the HVAC system components or by estimating the energy usage of the one or more HVAC system components based on detecting usage of components of the HVAC system. The module 537 can communicate energy monitoring information and the state of the HVAC system components to the thermostat 534 and can control the one or more components of the HVAC system based on commands received from the thermostat 534.

The system 500 includes face detection device 557. The face detection device 557 can be computing devices (e.g., a computer, microcontroller, FPGA, ASIC, or other device capable of electronic computation) capable of receiving data related to the face detection device and communicating electronically with the monitoring system control unit 510.

In some examples, the system 500 further includes one or more robotic devices 590. The robotic devices 590 may be any type of robots that are capable of moving and taking actions that assist in home monitoring. For example, the robotic devices 590 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and also roll along the ground, walls, or ceiling) and land vehicle type devices (e.g., automated cars that drive around a home). In some cases, the robotic devices 590 may be robotic devices 590 that are intended for other purposes and merely associated with the system 500 for use in appropriate circumstances. For instance, a robotic vacuum cleaner device may be associated with the monitoring system 500 as one of the robotic devices 590 and may be controlled to take action responsive to monitoring system events.

In some examples, the robotic devices 590 automatically navigate within a home. In these examples, the robotic devices 590 include sensors and control processors that guide movement of the robotic devices 590 within the home. For instance, the robotic devices 590 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 590 may include control processors that process output from the various sensors and control the robotic devices 590 to move along a path that reaches the desired destination and avoids obstacles. In this regard, the control processors detect walls or other obstacles in the home and guide movement of the robotic devices 590 in a manner that avoids the walls and other obstacles.

In addition, the robotic devices 590 may store data that describes attributes of the home. For instance, the robotic devices 590 may store a floorplan and/or a three-dimensional model of the home that enables the robotic devices 590 to navigate the home. During initial configuration, the robotic devices 590 may receive the data describing attributes of the home, determine a frame of reference to the data (e.g., a home or reference location in the home), and navigate the home based on the frame of reference and the data describing attributes of the home. Further, initial configuration of the robotic devices 590 also may include learning of one or more navigation patterns in which a user provides input to control the robotic devices 590 to perform a specific navigation action (e.g., fly to an upstairs bedroom and spin around while capturing video and then return to a home charging base). In this regard, the robotic devices 590 may learn and store the navigation patterns such that the robotic devices 590 may automatically repeat the specific navigation actions upon a later request.

In some examples, the robotic devices 590 may include data capture and recording devices. In these examples, the robotic devices 590 may include one or more cameras, one or more motion sensors, one or more microphones, one or more biometric data collection tools, one or more temperature sensors, one or more humidity sensors, one or more air flow sensors, and/or any other types of sensor that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 590 to take and store a biometric sample that can be used to identify the person (e.g., a biometric sample with DNA that can be used for DNA testing).

In some implementations, the robotic devices 590 may include output devices. In these implementations, the robotic devices 590 may include one or more displays, one or more speakers, and/or any type of output devices that allow the robotic devices 590 to communicate information to a nearby user.

The robotic devices 590 also may include a communication module that enables the robotic devices 590 to communicate with the control unit 510, each other, and/or other devices. The communication module may be a wireless communication module that allows the robotic devices 590 to communicate wirelessly. For instance, the communication module may be a Wi-Fi module that enables the robotic devices 590 to communicate over a local wireless network at the home. The communication module further may be a 900 MHz wireless communication module that enables the robotic devices 590 to communicate directly with the control unit 510. Other types of short-range wireless communication protocols, such as Bluetooth, Bluetooth LE, Z-wave, ZigBee, etc., may be used to allow the robotic devices 590 to communicate with other devices in the home. In some implementations, the robotic devices 590 may communicate with each other or with other devices of the system 500 through the network 505.

The robotic devices 590 further may include processor and storage capabilities. The robotic devices 590 may include any suitable processing devices that enable the robotic devices 590 to operate applications and perform the actions described throughout this disclosure. In addition, the robotic devices 590 may include solid-state electronic storage that enables the robotic devices 590 to store applications, configuration data, collected sensor data, and/or any other type of information available to the robotic devices 590.

The robotic devices 590 are associated with one or more charging stations. The charging stations may be located at predefined home base or reference locations in the home. The robotic devices 590 may be configured to navigate to the charging stations after completion of tasks needed to be performed for the property monitoring system 500. For instance, after completion of a monitoring operation or upon instruction by the control unit 510, the robotic devices 590 may be configured to automatically fly to and land on one of the charging stations. In this regard, the robotic devices 590 may automatically maintain a fully charged battery in a state in which the robotic devices 590 are ready for use by the property monitoring system 500.

The charging stations may be contact based charging stations and/or wireless charging stations. For contact based charging stations, the robotic devices 590 may have readily accessible points of contact that the robotic devices 590 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 590 may charge through a wireless exchange of power. In these cases, the robotic devices 590 need only locate themselves closely enough to the wireless charging stations for the wireless exchange of power to occur. In this regard, the positioning needed to land at a predefined home base or reference location in the home may be less precise than with a contact based charging station. Based on the robotic devices 590 landing at a wireless charging station, the wireless charging station outputs a wireless signal that the robotic devices 590 receive and convert to a power signal that charges a battery maintained on the robotic devices 590.

In some implementations, each of the robotic devices 590 has a corresponding and assigned charging station such that the number of robotic devices 590 equals the number of charging stations. In these implementations, the robotic devices 590 always navigate to the specific charging station assigned to that robotic device. For instance, a first robotic device may always use a first charging station and a second robotic device may always use a second charging station.

In some examples, the robotic devices 590 may share charging stations. For instance, the robotic devices 590 may use one or more community charging stations that are capable of charging multiple robotic devices 590. The community charging station may be configured to charge multiple robotic devices 590 in parallel. The community charging station may be configured to charge multiple robotic devices 590 in serial such that the multiple robotic devices 590 take turns charging and, when fully charged, return to a predefined home base or reference location in the home that is not associated with a charger. The number of community charging stations may be less than the number of robotic devices 590.

Also, the charging stations may not be assigned to specific robotic devices 590 and may be capable of charging any of the robotic devices 590. In this regard, the robotic devices 590 may use any suitable, unoccupied charging station when not in use. For instance, when one of the robotic devices 590 has completed an operation or is in need of battery charge, the control unit 510 references a stored table of the occupancy status of each charging station and instructs the robotic device to navigate to the nearest charging station that is unoccupied.

The system 500 further includes one or more integrated security devices 580. The one or more integrated security devices may include any type of device used to provide alerts based on received sensor data. For instance, the one or more control units 510 may provide one or more alerts to the one or more integrated security input/output devices 580. Additionally, the one or more control units 510 may receive sensor data from the sensors 520 and determine whether to provide an alert to the one or more integrated security input/output devices 580.

The sensors 520, the home automation controls 522, the camera 530, the thermostat 534, and the integrated security devices 580 may communicate with the controller 512 over communication links 524, 526, 528, 532, 538, and 584. The communication links 524, 526, 528, 532, 538, and 584 may be a wired or wireless data pathway configured to transmit signals from the sensors 520, the home automation controls 522, the camera 530, the thermostat 534, and the integrated security devices 580 to the controller 512. The sensors 520, the home automation controls 522, the camera 530, the thermostat 534, and the integrated security devices 580 may continuously transmit sensed values to the controller 512, periodically transmit sensed values to the controller 512, or transmit sensed values to the controller 512 in response to a change in a sensed value.

The communication links 524, 526, 528, 532, 538, and 584 may include a local network. The sensors 520, the home automation controls 522, the camera 530, the thermostat 534, and the integrated security devices 580, and the controller 512 may exchange data and commands over the local network. The local network may include 802.11 “Wi-Fi” wireless Ethernet (e.g., using low-power Wi-Fi chipsets), Z-Wave, ZigBee, Bluetooth, “HomePlug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 560 is an electronic device configured to provide monitoring services by exchanging electronic communications with the control unit 510, the one or more user devices 540 and 550, and the central alarm station server 570 over the network 505. For example, the monitoring server 560 may be configured to monitor events (e.g., alarm events) generated by the control unit 510. In this example, the monitoring server 560 may exchange electronic communications with the network module 514 included in the control unit 510 to receive information regarding events (e.g., alerts) detected by the control unit 510. The monitoring server 560 also may receive information regarding events (e.g., alerts) from the one or more user devices 540 and 550.

In some examples, the monitoring server 560 may route alert data received from the network module 514 or the one or more user devices 540 and 550 to the central alarm station server 570. For example, the monitoring server 560 may transmit the alert data to the central alarm station server 570 over the network 505.

The monitoring server 560 may store sensor and image data received from the monitoring system 500 and perform analysis of sensor and image data received from the monitoring system 500. Based on the analysis, the monitoring server 560 may communicate with and control aspects of the control unit 510 or the one or more user devices 540 and 550.

The monitoring server 560 may provide various monitoring services to the system 500. For example, the monitoring server 560 may analyze the sensor, image, and other data to determine an activity pattern of a resident of the home monitored by the system 500. In some implementations, the monitoring server 560 may analyze the data for alarm conditions or may determine and perform actions at the home by issuing commands to one or more of the controls 522, possibly through the control unit 510.

The central alarm station server 570 is an electronic device configured to provide alarm monitoring service by exchanging communications with the control unit 510, the one or more mobile devices 540 and 550, and the monitoring server 560 over the network 505. For example, the central alarm station server 570 may be configured to monitor alerting events generated by the control unit 510. In this example, the central alarm station server 570 may exchange communications with the network module 514 included in the control unit 510 to receive information regarding alerting events detected by the control unit 510. The central alarm station server 570 also may receive information regarding alerting events from the one or more mobile devices 540 and 550 and/or the monitoring server 560.

The central alarm station server 570 is connected to multiple terminals 572 and 574. The terminals 572 and 574 may be used by operators to process alerting events. For example, the central alarm station server 570 may route alerting data to the terminals 572 and 574 to enable an operator to process the alerting data. The terminals 572 and 574 may include general-purpose computers (e.g., desktop personal computers, workstations, or laptop computers) that are configured to receive alerting data from a server in the central alarm station server 570 and render a display of information based on the alerting data. For instance, the controller 512 may control the network module 514 to transmit, to the central alarm station server 570, alerting data indicating that a sensor 520 detected motion from a motion sensor via the sensors 520. The central alarm station server 570 may receive the alerting data and route the alerting data to the terminal 572 for processing by an operator associated with the terminal 572. The terminal 572 may render a display to the operator that includes information associated with the alerting event (e.g., the lock sensor data, the motion sensor data, the contact sensor data, etc.) and the operator may handle the alerting event based on the displayed information.

In some implementations, the terminals 572 and 574 may be mobile devices or devices designed for a specific function. Although FIG. 5 illustrates two terminals for brevity, actual implementations may include more (and, perhaps, many more) terminals.

The one or more authorized user devices 540 and 550 are devices that host and display user interfaces. For instance, the user device 540 is a mobile device that hosts or runs one or more native applications (e.g., the smart home application 542). The user device 540 may be a cellular phone or a non-cellular locally networked device with a display. The user device 540 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 540 may perform functions unrelated to the monitoring system, such as placing personal telephone calls, playing music, playing video, displaying pictures, browsing the Internet, maintaining an electronic calendar, etc.

The user device 540 includes a smart home application 542. The smart home application 542 refers to a software/firmware program running on the corresponding mobile device that enables the user interface and features described throughout. The user device 540 may load or install the smart home application 542 based on data received over a network or data received from local media. The smart home application 542 runs on mobile devices platforms, such as iPhone, iPod touch, Blackberry, Google Android, Windows Mobile, etc. The smart home application 542 enables the user device 540 to receive and process image and sensor data from the monitoring system.

The user device 550 may be a general-purpose computer (e.g., a desktop personal computer, a workstation, or a laptop computer) that is configured to communicate with the monitoring server 560 and/or the control unit 510 over the network 505. The user device 550 may be configured to display a smart home user interface 552 that is generated by the user device 550 or generated by the monitoring server 560. For example, the user device 550 may be configured to display a user interface (e.g., a web page) provided by the monitoring server 560 that enables a user to perceive images captured by the camera 530 and/or reports related to the monitoring system. Although FIG. 5 illustrates two user devices for brevity, actual implementations may include more (and, perhaps, many more) or fewer user devices.

In some implementations, the one or more user devices 540 and 550 communicate with and receive monitoring system data from the control unit 510 using the communication link 538. For instance, the one or more user devices 540 and 550 may communicate with the control unit 510 using various local wireless protocols such as Wi-Fi, Bluetooth, Z-wave, ZigBee, HomePlug (Ethernet over power line), or wired protocols such as Ethernet and USB, to connect the one or more user devices 540 and 550 to local security and automation equipment. The one or more user devices 540 and 550 may connect locally to the monitoring system and its sensors and other devices. The local connection may improve the speed of status and control communications because communicating through the network 505 with a remote server (e.g., the monitoring server 560) may be significantly slower.

Although the one or more user devices 540 and 550 are shown as communicating with the control unit 510, the one or more user devices 540 and 550 may communicate directly with the sensors and other devices controlled by the control unit 510. In some implementations, the one or more user devices 540 and 550 replace the control unit 510 and perform the functions of the control unit 510 for local monitoring and long range/offsite communication.

In other implementations, the one or more user devices 540 and 550 receive monitoring system data captured by the control unit 510 through the network 505. The one or more user devices 540, 550 may receive the data from the control unit 510 through the network 505 or the monitoring server 560 may relay data received from the control unit 510 to the one or more user devices 540 and 550 through the network 505. In this regard, the monitoring server 560 may facilitate communication between the one or more user devices 540 and 550 and the monitoring system.

In some implementations, the one or more user devices 540 and 550 may be configured to switch whether the one or more user devices 540 and 550 communicate with the control unit 510 directly (e.g., through communication link 538) or through the monitoring server 560 (e.g., through network 505) based on a location of the one or more user devices 540 and 550. For instance, when the one or more user devices 540 and 550 are located close to the control unit 510 and in range to communicate directly with the control unit 510, the one or more user devices 540 and 550 use direct communication. When the one or more user devices 540 and 550 are located far from the control unit 510 and not in range to communicate directly with the control unit 510, the one or more user devices 540 and 550 use communication through the monitoring server 560.

Although the one or more user devices 540 and 550 are shown as being connected to the network 505, in some implementations, the one or more user devices 540 and 550 are not connected to the network 505. In these implementations, the one or more user devices 540 and 550 communicate directly with one or more of the monitoring system components and no network (e.g., Internet) connection or reliance on remote servers is needed.

In some implementations, the one or more user devices 540 and 550 are used in conjunction with only local sensors and/or local devices in a house. In these implementations, the system 500 includes the one or more user devices 540 and 550, the sensors 520, the home automation controls 522, the camera 530, the robotic devices 590, and the face detection device 557. The one or more user devices 540 and 550 receive data directly from the sensors 520, the home automation controls 522, the camera 530, the robotic devices 590, and the face detection device 557 and sends data directly to the sensors 520, the home automation controls 522, the camera 530, the robotic devices 590, and the face detection device 557. The one or more user devices 540, 550 provide the appropriate interfaces/processing to provide visual surveillance and reporting.

In other implementations, the system 500 further includes network 505 and the sensors 520, the home automation controls 522, the camera 530, the thermostat 534, the robotic devices 590, and the face detection device 557 are configured to communicate sensor and image data to the one or more user devices 540 and 550 over network 505 (e.g., the Internet, cellular network, etc.). In yet another implementation, the sensors 520, the home automation controls 522, the camera 530, the thermostat 534, the robotic devices 590, and the face detection device 557 (or a component, such as a bridge/router) are intelligent enough to change the communication pathway from a direct local pathway when the one or more user devices 540 and 550 are in close physical proximity to the sensors 520, the home automation controls 522, the camera 530, the thermostat 534, the robotic devices 590, and the face detection device 557 to a pathway over network 505 when the one or more user devices 540 and 550 are farther from the sensors 520, the home automation controls 522, the camera 530, the thermostat 534, the robotic devices 590, and the face detection device 557. In some examples, the system leverages GPS information from the one or more user devices 540 and 550 to determine whether the one or more user devices 540 and 550 are close enough to the sensors 520, the home automation controls 522, the camera 530, the thermostat 534, the robotic devices 590, and the face detection device 557 to use the direct local pathway or whether the one or more user devices 540 and 550 are far enough from the sensors 520, the home automation controls 522, the camera 530, the thermostat 534, the robotic devices 590, and the face detection device 557 that the pathway over network 505 is required. In other examples, the system leverages status communications (e.g., pinging) between the one or more user devices 540 and 550 and the sensors 520, the home automation controls 522, the camera 530, the thermostat 534, the robotic devices 590, and the face detection device 557 to determine whether communication using the direct local pathway is possible. If communication using the direct local pathway is possible, the one or more user devices 540 and 550 communicate with the sensors 520, the home automation controls 522, the camera 530, the thermostat 534, the robotic devices 590, and the face detection device 557 using the direct local pathway. If communication using the direct local pathway is not possible, the one or more user devices 540 and 550 communicate with the sensors 520, the home automation controls 522, the camera 530, the thermostat 534, the robotic devices 590, and the face detection device 557 using the pathway over network 505.

In some implementations, the system 500 provides end users with access to images captured by the camera 530 to aid in decision-making. The system 500 may transmit the images captured by the camera 530 over a wireless WAN network to the user devices 540 and 550. Because transmission over a wireless WAN network may be relatively expensive, the system 500 can use several techniques to reduce costs while providing access to significant levels of useful visual information (e.g., compressing data, down-sampling data, sending data only over inexpensive LAN connections, or other techniques).

In some implementations, a state of the monitoring system 500 and other events sensed by the monitoring system 500 may be used to enable/disable video/image recording devices (e.g., the camera 530). In these implementations, the camera 530 may be set to capture images on a periodic basis when the alarm system is armed in an “away” state, but set not to capture images when the alarm system is armed in a “home” state or disarmed. In addition, the camera 530 may be triggered to begin capturing images when the alarm system detects an event, such as an alarm event, a door-opening event for a door that leads to an area within a field of view of the camera 530, or motion in the area within the field of view of the camera 530. In other implementations, the camera 530 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A system comprising one or more computers and one or more storage devices on which are stored instructions that are operable, when executed by the one or more computers, to cause the one or more computers to perform operations comprising:
obtaining, from at least one image in a plurality of first images, one or more person bounding boxes and one or more face bounding boxes that each correspond to one of the one or more the person bounding boxes, wherein each person bounding box identifies at least one portion of a respective image of the plurality of first images that likely represents a person;
training a face location predictor to predict a location of a face in an image using the one or more person bounding boxes and the one or more face bounding boxes;
training, using the face location predictor, an error model that determines a likelihood that an image depicts a face using output from the face location predictor; and
storing, in memory, the trained error model, and the face location predictor for use by a device detecting one or more faces depicted in an image.

2. The system of claim 1, wherein the operations further comprise:
receiving one or more input images;
determining whether each of the one or more input images likely depicts at least one person;
for each of the one or more input images that likely depict at least one person, generating a corresponding person bounding box; and
selecting, as the plurality of first images, the one or more input images that each likely depict at least one person.

3. The system of claim 1, wherein the operations further comprise:
detecting a face depicted in an image using the face location predictor, the error model, and a face detector that detects faces in images using data from the face location predictor and the error model; and
in response to detecting the face depicted in the image, performing one or more automated actions using data for the face.

4. The system of claim 3, wherein performing the one or more automated actions using the data for the face comprises:
determining, for the face, one or more face prior values that comprise at least one of a face bounding box center location, or a face bounding box size;
determining a difference between the determined one or more face prior values and one or more ground-truth values; and
performing the one or more automated actions in response to determining that the difference between the determined one or more face prior values and the one or more ground-truth values satisfies a difference threshold.

5. The system of claim 3, wherein:
detecting the face using the face location predictor, the error model, and the face detector comprises:
determining, for the face, a likelihood that the face is a false detection; and
determining that the likelihood satisfies a threshold likelihood; and
performing the one or more automated actions is responsive to determining that the likelihood satisfies the threshold likelihood.

6. The system of claim 3, wherein performing the one or more automated actions using the data for the face comprises sending, to a device, instructions to cause the device to lock or unlock a door.

7. The system of claim 1, wherein obtaining the one or more person bounding boxes and the one or more face bounding boxes of comprises:
for each person bounding box:
extracting, using the respective person bounding box and image from the plurality of first images, features i) from the image, and ii) that comprise a combination of one or more of a person box size, a person center position, or a person footprint position;
using the extracted features for each person bounding box, determining a predicted location and a predicted size of a face associated with the person bounding box; and
using the predicted location and the predicted size of the face associated with the person bounding box, generating a face bounding box corresponding to the respective person bounding box.

8. The system of claim 1, wherein training the face location predictor using the one or more person bounding boxes and the one or more face bounding boxes comprises:
determining that a portion of at least a first image i) of the plurality of first images and ii) that corresponds to a person bounding box satisfies a likelihood threshold of depicting a face; and
training the face location predictor using at least the first image.

9. The system of claim 1, wherein training the face location predictor using the one or more person bounding boxes and the one or more face bounding boxes comprises:
determining that a portion of at least a second image i) of the plurality of first images and ii) that corresponds to a person bounding box does not satisfy a likelihood threshold of including a face; and
determining to skip training the face location predictor using the second image.

10. The system of claim 1, wherein obtaining the one or more person bounding boxes and the one or more face bounding boxes comprises:
obtaining the one or more person bounding boxes;
in response to obtaining the one or more person bounding boxes, cropping a subset of images from the plurality of first images to only include portions of the respective first image that are within a respective person bounding box from the one or more person bounding boxes; and
obtaining, using the cropped subset of images from the plurality of first images, the one or more face bounding boxes.

11. The system of claim 1, wherein training the face location predictor uses a combination of one or more person bounding box features, wherein the one or more person bounding box features comprise at least one of a person bounding box size, a person bounding box aspect ratio, a predicted person center position, or a predicted person footprint position.

12. A method comprising:
detecting a face candidate depicted in an image using data for the image and a face location predictor that was trained to predict a location of a face in an image using one or more person bounding boxes and one or more face bounding boxes that each correspond to one of the one or more the person bounding boxes, wherein each person bounding box identifies at least one portion of the image that likely represents a person;
determining a likelihood that the image actually depicts a face using an error model that determines likelihoods that images depict at least one face using output from the face location predictor;
determining, using a face detector that detects faces in images using data from the face location predictor and the error model, whether the face candidate satisfies a threshold likelihood of representing an actual face depicted in the image; and
in response to determining whether the face candidate satisfies the threshold likelihood of representing an actual face depicted in the image, selectively performing one or more automated actions using data for the face or determining to skip performing the one or more automated actions.

13. The method of claim 12, comprising performing the one or more automated actions using the data for the face.

14. The method of claim 13, wherein performing the one or more automated actions using the data for the face comprises:
determining, for the face, one or more face prior values that comprise at least one of a face bounding box center location, or a face bounding box size;
determining a difference between the determined one or more face prior values and one or more ground-truth values; and
performing the one or more automated actions in response to determining that the difference between the determined one or more face prior values and the one or more ground-truth values satisfies a difference threshold.

15. The method of claim 13, wherein performing the one or more automated actions using the data for the face comprises sending, to a device, instructions to cause the device to lock or unlock a door.

16. The method of claim 12, wherein:
determining whether the face candidate satisfies a threshold likelihood of representing an actual face depicted in the image comprises:
determining, for the face, whether the likelihood satisfies the threshold likelihood of representing an actual face and being a true face detection; and
in response to determining that the likelihood satisfies the threshold likelihood of representing an actual face and being a true face detection, performing facial recognition for the face; and
performing the one or more automated actions uses data representing a result of the facial recognition for the face.

17. One or more non-transitory computer storage media encoded with instructions that, when executed by one or more computers, cause the one or more computers to perform operations comprising:
obtaining, from at least one image in a plurality of first images, one or more person bounding boxes and one or more face bounding boxes that each correspond to one of the one or more the person bounding boxes, wherein each person bounding box identifies at least one portion of a respective image of the plurality of first images that likely represents a person;
training a face location predictor to predict a location of a face in an image using the one or more person bounding boxes and the one or more face bounding boxes;
training, using the face location predictor, an error model that determines a likelihood that an image depicts a face using output from the face location predictor; and
storing, in memory, the trained error model, and the face location predictor for use by a device detecting one or more faces depicted in an image.

18. The non-transitory computer storage media of claim 17, wherein the operations further comprise:
receiving one or more input images;
determining whether each of the one or more input images likely depicts at least one person;
for each of the one or more input images that likely depict at least one person, generating a corresponding person bounding box; and
selecting, as the plurality of first images, the one or more input images that each likely depict at least one person.

19. The non-transitory computer storage media of claim 17, wherein the operations further comprise:
detecting a face depicted in an image using the face location predictor, the error model, and a face detector that detects faces in images using data from the face location predictor and the error model; and
in response to detecting the face depicted in the image, performing one or more automated actions using data for the face.

20. The non-transitory computer storage media of claim 19, wherein performing the one or more automated actions using the data for the face comprises:
determining, for the face, one or more face prior values that comprise at least one of a face bounding box center location, or a face bounding box size;
determining a difference between the determined one or more face prior values and one or more ground-truth values; and
performing the one or more automated actions in response to determining that the difference between the determined one or more face prior values and the one or more ground-truth values satisfies a difference threshold.
